(19) United States
(12) Patent Application Publication
(10) Pub. No.: US 2011/0007157 A1
(43) Pub. Date: Jan. 13, 2011

(54) Mechanical stabilization and automated positional corrections for stationary or mobile surveillance systems

(76) Inventors: Stephen Sekelsky, New York, NY (US); Kalpesh Desai, Woodbury, NY (US); Stella Wang, Lake Grove, NY (US); Steve Ostapow, Garden City, NY (US)

Correspondence Address: Thomas A. O'Rourke;Bodner & O'Rourke, LLP, Suite 108, 425 Broadhollow Road, Melville, NY, 11747, US

(21) Appl. No.: 12/661,466

(22) Filed: Mar. 17, 2010

Related U.S. Application Data
(60) Provisional application No. 61/210,357, filed on Mar. 17, 2009.

(51) Int. Cl. H04N 7/18

(52) U.S. Cl. 348/143; 348/E07.085

(57) ABSTRACT

A system for providing mechanical stabilization with automated corrections for stationary or mobile surveillance platforms comprises: a telescoping mast that supports a sensor package containing a camera, surveillance radar, a pan tilt unit, and a tilt sensor with a precision compass. Stabilization involves hardware and software enhancements to conventional surveillance systems. Mast stabilization is achieved by a mechanical guy-wire arrangement which provides for both anti-twist and anti-sway support of the mast upper end through a crisscrossed guy wire arrangement. Eight different software algorithms contribute to stability and highly accurate and rapid slewing of the surveillance equipment. A mast tilt calibration algorithm in combination with a calibration sensor package provides for automatic electronic leveling of the camera with dwells at predetermined pan angles. A mast stability measurement algorithm assesses mechanical stability of the mast by comparing measured mass tilt versus pan characteristics to an ideal curve for a perfectly stabile mast.

This application claims priority on U.S. Provisional Application Ser. No. 61/210,357 filed on Mar. 17, 2009, the disclosures of which are incorporated herein by reference.

### FIELD OF THE INVENTION

The present invention is directed to a system, apparatus and method for highly accurate and rapid slewing of surveillance equipment to fixed map locations and to targets tracked by ground surveillance radar. The system has particular application in fixed and mobile surveillance systems including but not limited to border and facilities surveillance applications.

### BACKGROUND OF THE INVENTION

Current surveillance products with integrated camera and radar provide a rudimentary slew-to-cue feature. One of the problems with current surveillance products is that they do not account for terrain and require manual operations to set tilt and make adjustments to pan to account for system errors.

Systems using the known art typically provide a map interface that allows the user to click on a map location or radar tracked target and point a camera toward the target. These systems are manually operated, have a manual tilt setting and do not account for mechanical instabilities in the platform. In addition, they do not accurately account for mechanical errors versus the pan angle, which limits the systems pointing accuracy and prevents automated camera positioning.

### OBJECTS OF THE INVENTION

It is an object of the invention to provide a means of mechanically stabilizing a surveillance system to counter sway.

It is another object of the invention to provide a means of stabilizing a telescoping a mast system to counter twist.

It is a further object of the invention to provide a means of electronically leveling a camera system.

It is another object of the invention to provide a system that accounts for mast tilt as a function of pan angle.

It is also an object of the invention to provide a system to provide corrections related to the static environment such as terrain.

### SUMMARY OF THE INVENTION

The present invention provides an accurate and cost-effective method for positioning cameras, spotlights, illuminators and other sensors either at fixed or movable locations and will identify fixed and moving targets tracked by ground surveillance radar. In tracking targets the invention takes into consideration platform mechanical errors such as mast twist and sway and mast tilt. The present invention utilizes digital terrain data to implement an auto-tilt sub-feature and provides a search capability to account for inaccuracies in the radar reported target position.

In manned surveillance systems, the invention provides the advantage of enhancing the effectiveness of operators and reduces fatigue by automating the pan, tilt and focus functions. In automated surveillance systems, the invention provides the key infrastructure and processes required for slewing to a target and providing video to remote operators or automated classification algorithms.

The invention described herein provides sufficient pointing accuracy to automate camera slewing to a geographic location or to a radar tracked target. Existing systems based on the known art require the operator to manually adjust the camera to account for system pointing inaccuracies. This is avoided in the present invention.

The system of the present invention provides high accuracy and rapid slewing to the target. Additional benefits include a dramatic reduction in the operator workload, as well as an increase in the overall system efficiency. The present invention accomplishes these efficiencies by reducing the time it takes to point the camera for identifying radar targets. The system also provides core functions required for system automation by providing accurate camera slewing.

### BRIEF DESCRIPTION OF THE DRAWINGS

FIG. 1 shows a surveillance system on a ground-surface-mounted telescoping mast, with a guy-wire stabilized torque arm according to the current invention.

FIG. 1 A shows mobile deployment of the mast-mounted surveillance system of FIG. 1 in a hilly region, with deployment using a telescoping mast mounted to a truck bed.

FIG. 1B shows mobile deployment of the mast-mounted surveillance system of FIG. 1 in level terrain, with deployment using a telescoping mast mounted to a truck bed.

FIG. 1C is an enlarged view of the mast-mounted surveillance system of FIG. 1, showing one embodiment where the sensor suit components comprise a tilt sensor, a radar, and a day and a thermal camera.

FIG. 2 shows mobile deployment of an alternative embodiment of the mast-mounted surveillance system of FIG. 1A, where the torque arm is replaced by a guy-wire stabilized plate that supports the surveillance system equipment.

FIG. 3 is one embodiment of a deployable tactical radar system, the ARSS, which is capable of detecting ground and low flying airborne targets.

FIG. 3A is a radar set-up and operation screen of the user interface of FIG. 3.

FIG. 4 is one embodiment of a camera that may be utilized with the current invention and its specifications, where the camera is a day/night camera.

FIG. 5 shows one embodiment of a suitable tilt sensor for use in the current invention, and the components of the sensor.

FIG. 6 is a flow chart showing the interaction of the MSS sensors with the tilt sensor in conjunction with the mapping and video features.

FIG. 7 is a schematic illustrating the multi-sensor data fusion capability of the system for display to a customer COP (common operating picture).

FIG. 7A is a photograph of the sensor interface of the sensor processing unit.

FIG. 8 shows a signal processing unit where the signal processing unit of the present invention is integrated with an existing MSS system.

FIG. 9 shows a software architecture overview for the system.

FIG. 10 is a schematic overview of the overall operation of the stabilized, mast-mounted surveillance system of the current invention.

FIG. 11A is a flow chart showing the steps necessary for proper system deployment, including the calibration process.

FIG. 11B is a flow chart showing the real time pointing algorithm, after calibration is complete, whereby real time pointing control is achieved.

FIG. 11C is a screen shot showing the precision optical calibration process and resulting pan/tilt accuracy achieved.

FIG. 12 illustrates the pitch angle variations (pitch errors) which result for uncorrected mast tilt, for various azimuth angles.

FIG. 13 is a graphical comparison of Pitch versus Azimuth measurements for both a non-guy-wire supported mast and a guy wire supported mast.

FIG. 14 shows a representative radar field of view (light area) and camera field of view (dark area) for a short range target scenario.

FIG. 15 shows the radar field of view (dark area) and the camera field of view (light area) when the camera searches within the radar sample volume to more precisely identify the target location.

FIG. 16 shows a long range detection scheme for fast moving target.

FIG. 17 shows a detection scheme for slow targets at long range.

FIG. 18 is a flow chart showing the process steps of the fast moving target detection algorithm.

FIG. 19 is a flow chart showing the process steps of the long range search algorithm.

### DETAILED DESCRIPTION OF THE INVENTION

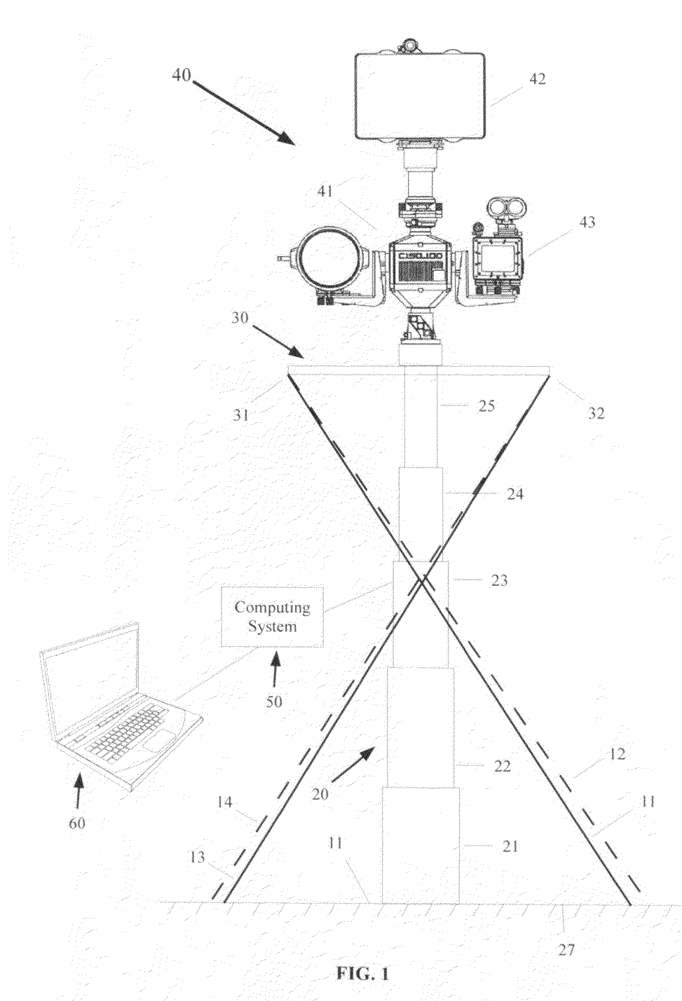

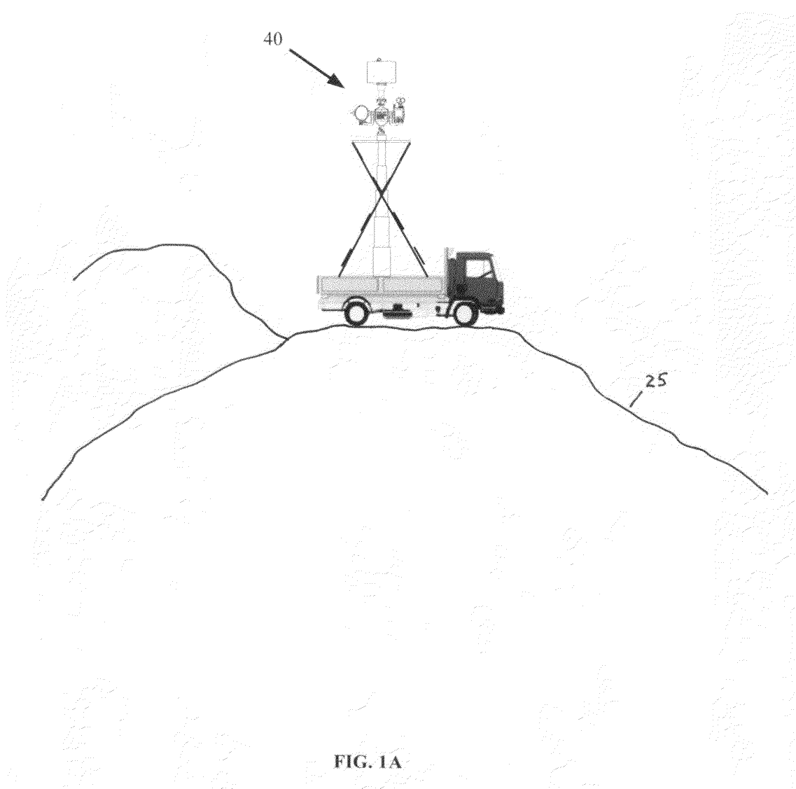

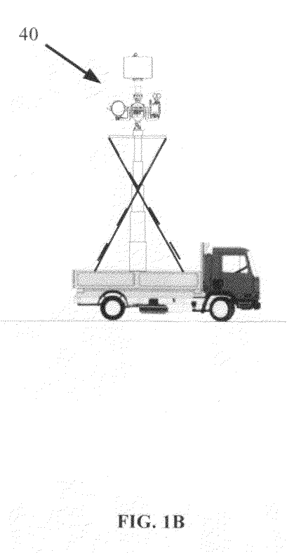

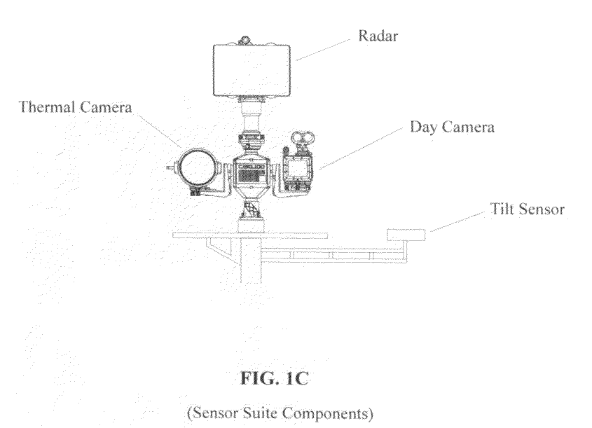

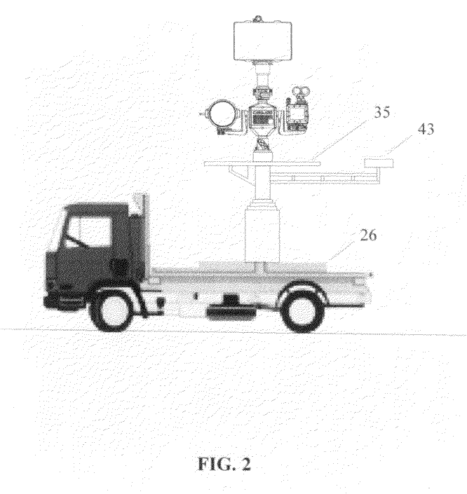

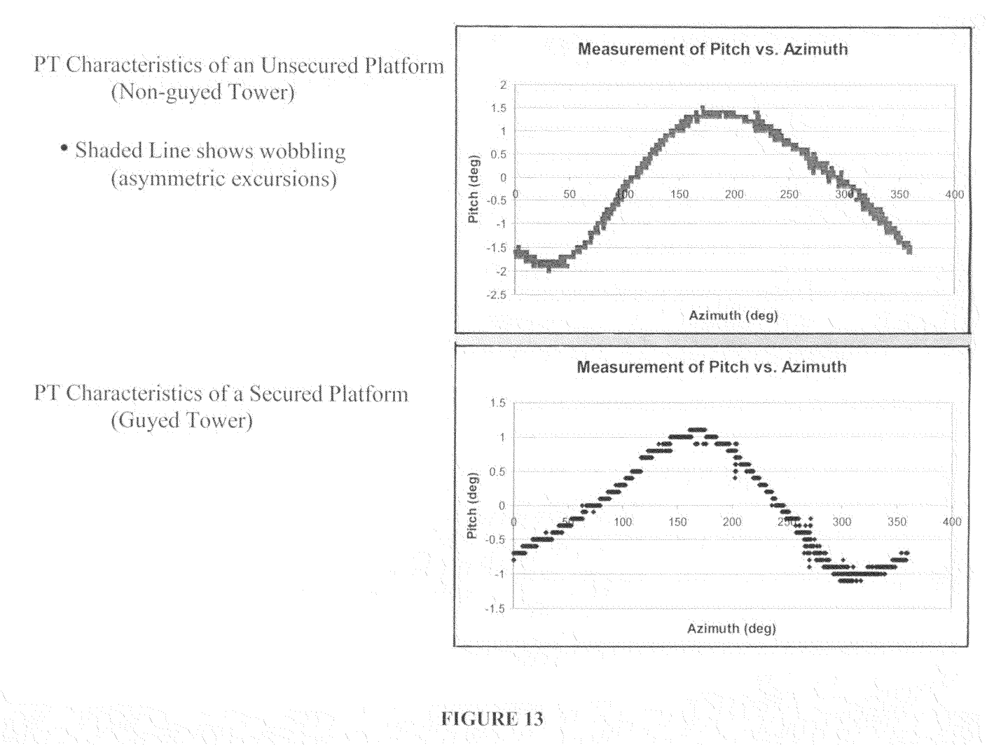

As seen in FIG. 1, a long range surveillance system 10 may be comprised of a unitary mast (not shown) or a telescoping mast 20, having a lower end 21, and an upper end 25. The mast 20 may have any number of telescoping sections, which may occupy a collapsed or unextended position, and which may be actuated to telescope outward into an extended position. In the mast pictured in FIG. 1, there were five sections, 21-25. The mast 20 may be positioned on a suitable mounting surface 11, which may be either a ground-based surface 25 (FIG. 1) or a stationary platform surface, or alternatively, a mobile platform surface may be utilized for a particular application. The mobile platform may be a skid 26 (FIG. 2) to which the mast may be mounted, where the skid is positioned atop a truck bed surface, as illustrated in FIG. 1A. The lower end of the mast 21 may be secured to the surface 11 using any suitable means, thereby allowing the mast top end to telescope upward to a desired height. For the ground-based system, the mast may simply be buried in the soil and the guy wires staked therein as well, or a concrete platform may be poured to constitute the mounting surface, into which, or onto which, the mast may be permanently or removably affixed. A removable option might involve couplings or brackets to secure the mast. The upper end of the mast 25 may comprise a torque arm 30 that permits the mast upper end to also be secured to the ground or platform by the use of one or more guy wires to prevent torque to the mast or twisting of the mast, and may thus be considered to be an anti-torque member. Some existing systems have rudimentary guy wire configurations for stability (see FIG. 13), however, they do not address twist, as with the preferred embodiment of the current invention.

The torque arm 30 is a member that may be generally tubular that extends relatively parallel to the support surface on which the mast is mounted, and be generally transverse to the mast 20. The torque 30 arm may be secured to the mast upper end 25 by any suitable means known in the art. In one embodiment, the upper end 25 of the mast may have a ring. This ring may have a first opening and a second opening on either side thereof.

The torque arm may have a first end 31 and a second end 32. At generally the first and second ends, guy wires may preferably be secured to the torque arm in a crisscrossed orientation, rather than triangular orientation or a trapezoidal orientation, which would also require a larger available mounting surface area. In a preferred embodiment, as seen in FIG. 1, the crisscrossed orientation may comprises two pairs of guy wires, where first and second guy wires, 11 and 12, forming the first pair, may be secured to the first end 31 of the torque arm 30. One guy wire—wire 11—may extend from the torque arm first end 31 toward the mounting surface and may pass in front of the telescoping mast 20 to be secured to the mounting surface 11. The second guy wire—wire 12—may also extend from the first end 31 of the torque-arm 30 but may pass along the rear (opposite side) of the telescoping mast to be secured to the mounting surface 11. Similarly, on the second end 32 of the torque arm 30 there may be first and second guy wires—wires 13 and 14—that extend from the second end of the torque arm to be secured to the mounting surface 11. As with the case of the first pair of guy wires, one wire—wire 13—may pass in front of the telescoping mast, and the other wire—wire 14—may pass to the rear of (opposite side of) mast 20.

The material utilized for each of the guy wires may preferably be selected so as to reduce tension variation over diurnal cycles-cycles comprising increasing and decreasing temperatures and moisture levels. One preferred material is Kevlar. However, there are other suitable materials, and methods of improving such material, such as those found in U.S. Pat. No. 5,357,726 to Effenberger for “Composite Materials for Structural End Uses,” the disclosures of which are incorporated herein by reference. Effenberger discloses reinforced textile composite material for tensioned fabric structures for sheltering from the outdoor environment.

The tension in each of the guy wires should preferably be approximately the same for all of the wires. The amount of tension used may vary, depending upon the dimensions of the mast to be supported, particularly its height above the mounting surface, the size of the sensor package sitting thereon, and the anticipated wind and other conditions at a deployment location. However, for the arrangement of FIGS. 1 and 1A, the guy wires may preferably be tensioned to approximately 85 pounds to provide sufficient anti-twist and anti-sway support for the mast 20.

As an alternative to the torque arm, a rigid flat plate 35 (FIG. 2) may be affixed to the mast upper end and serve as an anti-torque plate. The plate would permit attachment thereto of additional pairs of guy wires to support the mast.

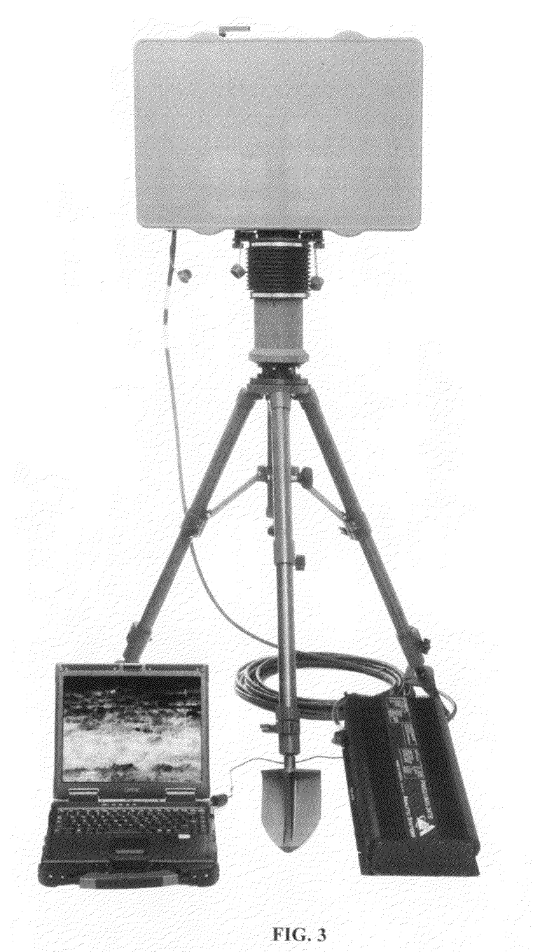

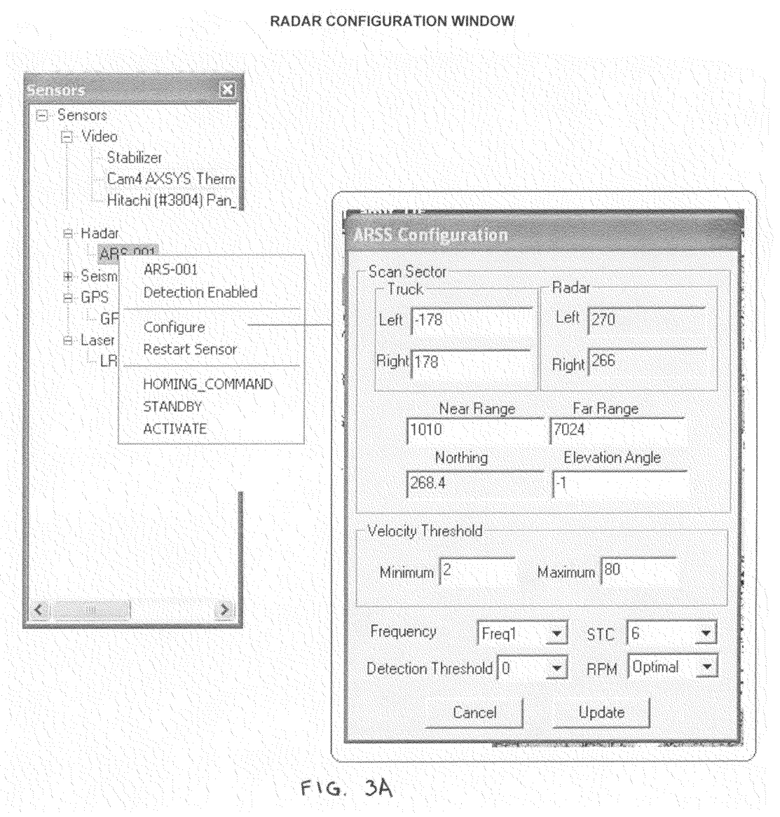

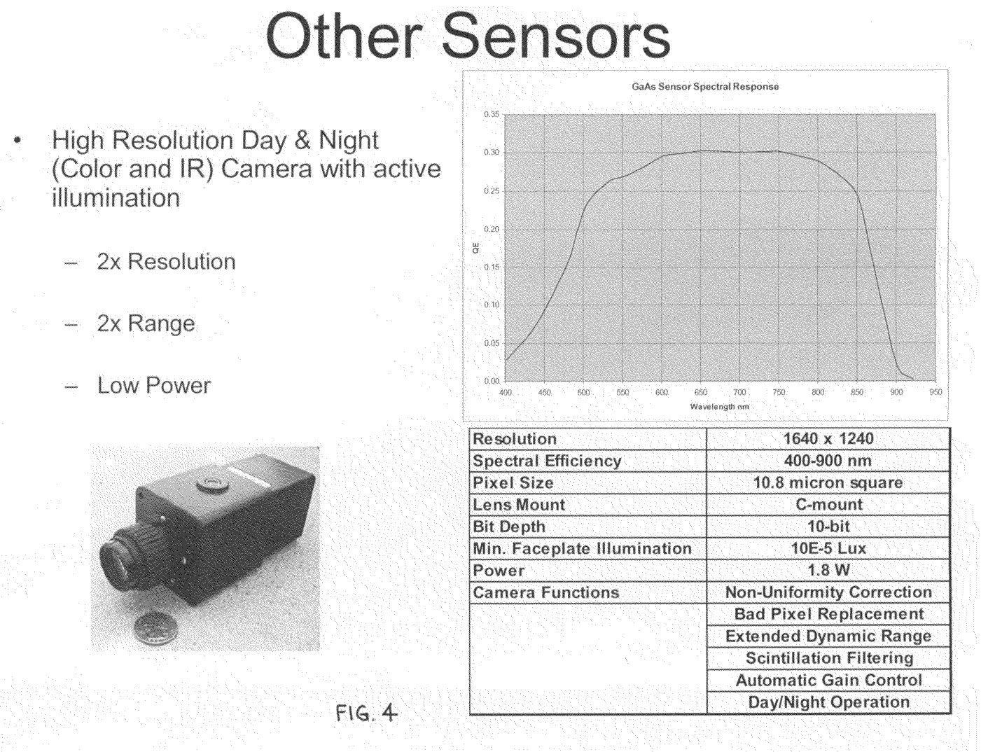

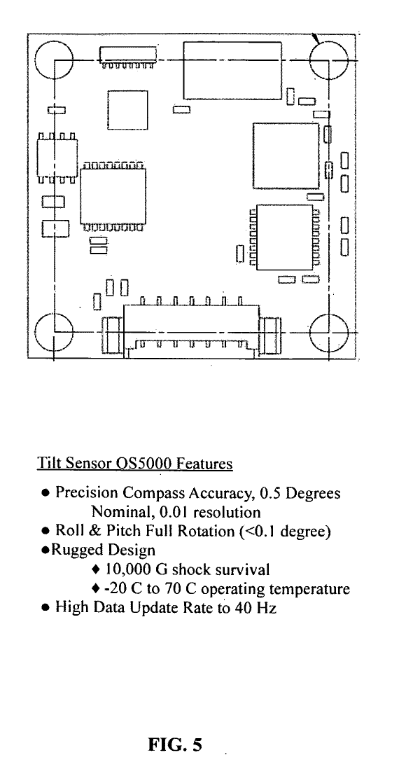

Secured to the torque arm 30 may be a sensor package 40 which may include one or more of a camera 41, a surveillance radar means 42, and a tilt sensor with magnetic compass 43. The camera 41 may be a high resolution day or night camera, or it may have capabilities for both. The camera 41 may also have color capability, or have both color and infrared capability. The surveillance radar 42 may be ground surveillance radar, or it may be tactical radar system capable of detecting ground and low flying airborne targets, such as the Advanced Radar Surveillance System (ARSS) of FIG. 3. The ARSS was developed from two-man portable radar for military use, and may receive a data and power cable to connect the primary components of the ARSS (transmitter receiver antenna and drive pedestal unit) to a computer and display unit. The sensor package may also include a tilt sensor with a compass 43. The compass may be a magnetic compass. The compass may preferably be the precision accuracy compass of FIG. 5. The sensor package may be connected to a computing system 50, which may have a user interface 60 associated therewith.

The long range surveillance system 10 of the present invention provides mechanical stabilization for low-cost deployable towers typically found on mobile surveillance platforms. The stabilization of the system 10 is adapted to minimize mast sway and mast twist. Existing systems have either no mechanical stabilization or rudimentary guy wire configurations that do not address twist.

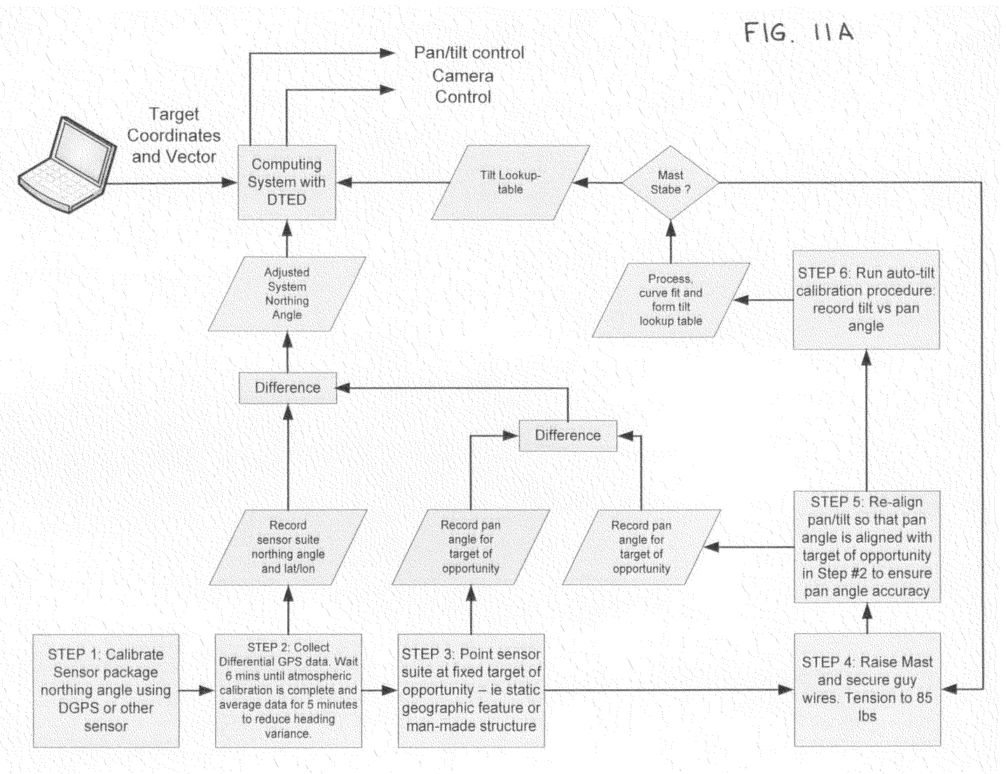

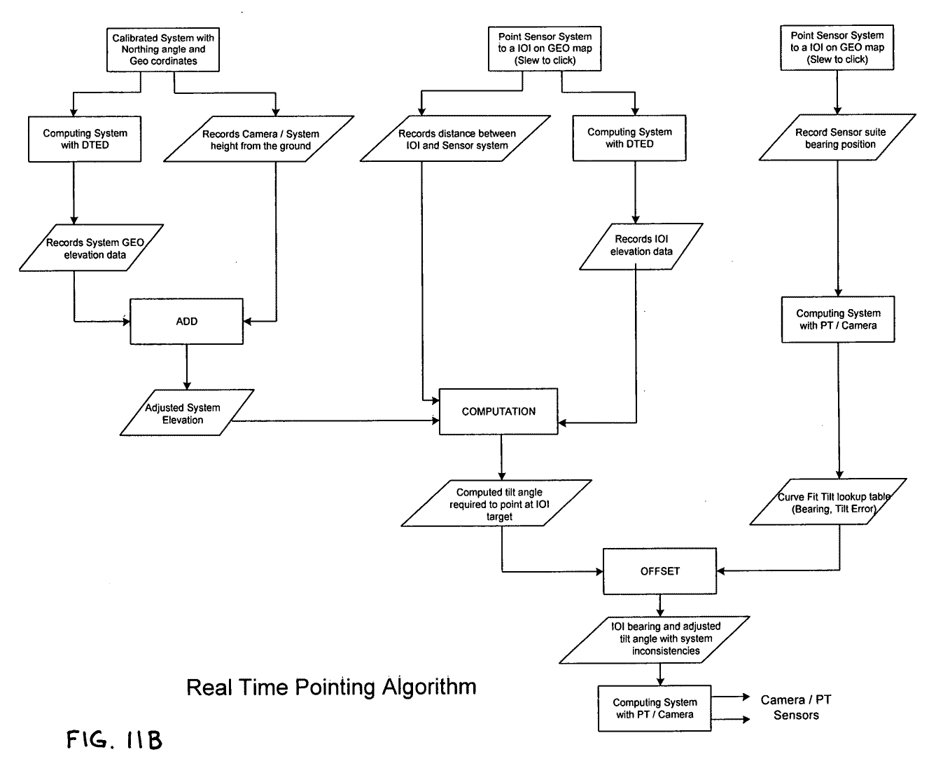

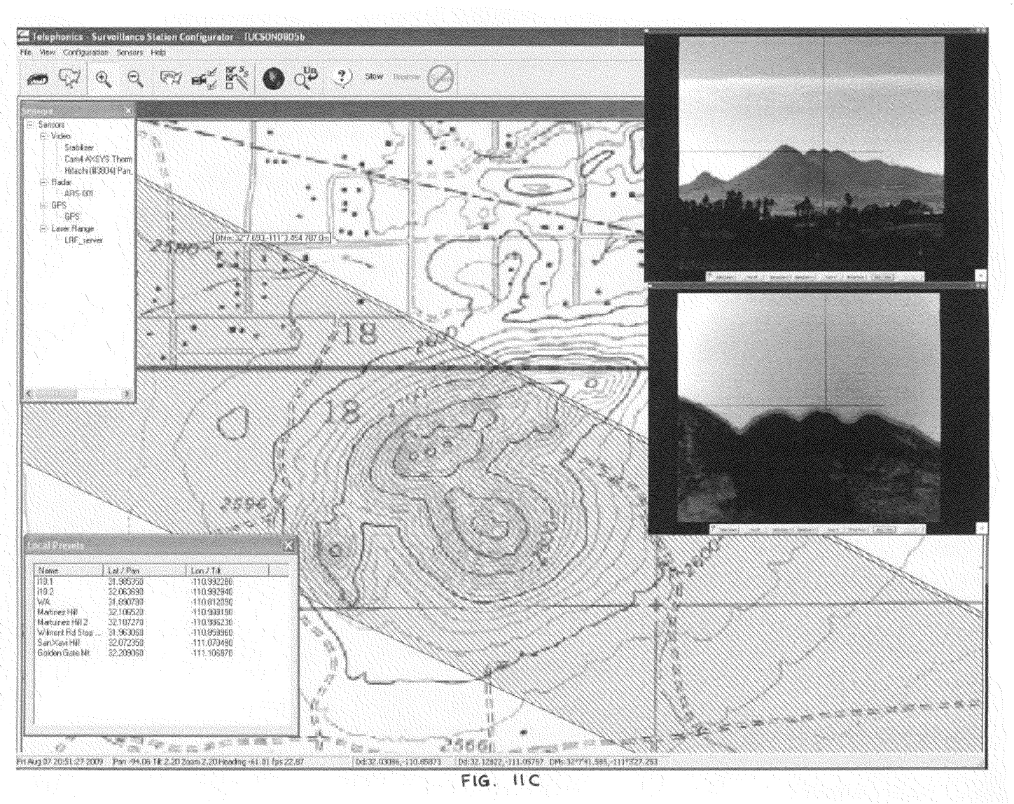

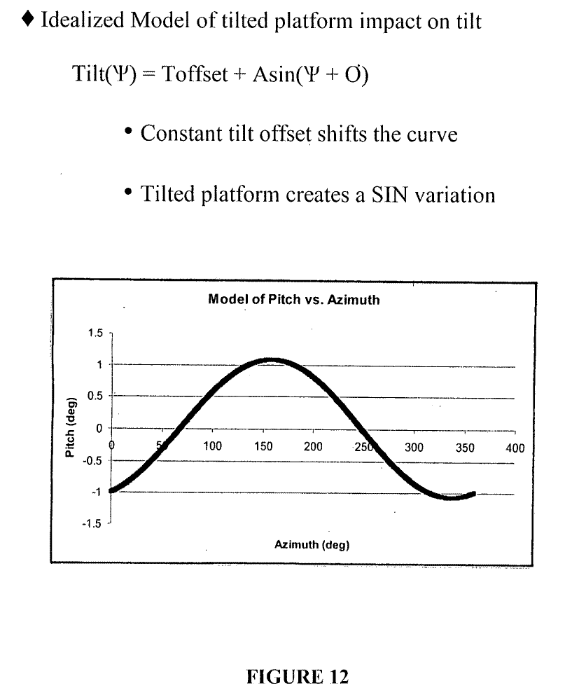

The system 10 of the present invention additionally provides measurement hardware and software algorithms for “electronically” leveling the camera system to eliminate pointing errors in pan (azimuth) and tilt (elevation) (see FIG. 11A). Existing systems attempt to level the mast and does not does not go further to account for any mast tilt, which thereafter induces an error that is a function of pan angle (see FIG. 12), and which is a recurring problem for a mobile surveillance system. The measurement hardware Tilt corrections are designed to adjust for the static environment of a particular deployment including terrain, but not real time variations such as an operator jumping onto the truck-mounted system, which may require a gimbal mounted gyro stabilization system. However, the system herein is far less expensive than a gimbal mounted gyro stabilized system, and any wind induced variation is nonetheless controlled herein by the mast stability of the guy wire arrangement. Corrections may include atmospheric corrections and scintillation heat wave-corrections.

Basic mast plumb is corrected by level sensors and actuators to establish a vertical alignment to approximately 0.5 degrees from a starting error of as much as approximately seven degrees. The pan and tilt mechanism is fitted with a level sensor that further corrects that measurement to define a level plane upon which the sensors are rotated in azimuth. Truck stability due to operation motion may best be accommodated using four corner stabilizers, which, again, is far less costly than real time motion compensation. Tilt data curve fitting essentially corrects the plane in which the pan and tilt rotates to a flat and level plane.

The system 10 may also store and use a digital terrain elevation database (DTED) for automated positioning of the camera tilt angle, to improve long range detection target acquisition in non-flat terrain. Existing systems require the operator to adjust the camera tilt. The system 10 estimates radar target position uncertainties and provides a scan pattern of this region for slew-to-cue to account for potential inaccuracies in the reported radar target position.

The system disclosed herein first provides for positional accuracy through an initial calibration process that establishes a northing angle, and which makes use of a Differential Global Positioning System (DGPS), which is an enhancement to GPS. DGPS utilizes a network of fixed, ground-based reference stations, which broadcast the difference between the positions indicated by the satellite systems and their known fixed positions. The stations broadcast the difference between the measured satellite pseudoranges (a satellite to receiver distance estimate) and actual, internally computed, pseudoranges. A receiver station may utilize the broadcast to correct their pseudoranges by the same amount. This correction signal is usually broadcast over. UHF radio. The U.S. coast guard operates a DPGS system between 285 kHz and 325 kHz.

In the calibration process, the system's pointing reference is calibrated to geographic north. A secondary correction also results, which accounts for any mast twist as a result of having a telescoping mast. Mast twist, may occur if the deployment elevation is changed, or if the stabilization suffers from diurnal effects. The system also makes use of a target of opportunity—a distant and static geographic feature or man-made structure. The concept herein can significantly improve the pointing calibration by aligning that static geographic feature in an image sensor cross hair and correct the pointing angle in both azimuth and elevation with the two known points, the sensor location using DGPS and the feature location.

Having stored the feature image used for calibration and the reference location at which it is found, the calibration update can be performed quickly, vastly reducing operator workload, while maintaining very accurate calibration with an inexpensive solution. This technique also may provide adjustments for any diurnal effects arising within a fixed mast system, as well as pan and tilt pointing offsets over time. It can also inexpensively deal with maintenance issues such as sensor mounting misalignment which occurs over time.

FIG. 2 contains a flow chart that represents the system deployment and calibration process. The calibration process has the following steps:
1. The calibration sensor package determines a northing angle using a Differential Global Positioning System (DGPS) or other sensor.
2. Differential GPS data is collected. A short period of time is permitted to pass (about six (6) minutes for example) to permit atmospheric calibrations to be completed. Data is averaged over an interval such as about five (5) minutes to reduce heading variance.
3. The sensor suite is pointed at a fixed target of opportunity. The target can be a static geographic feature, a man made structure or a person.
4. The mast is raised and secured with the guy wires. The tension on the wires should be sufficient to prevent swaying of the mast.
5. The pan/tilt is realigned so that the pan angle is aligned with the target of opportunity in step 2 to ensure pan angle accuracy.
6. The auto tilt calibration procedure is run. Tilt versus pan angle is recorded.

The measurement hardware consists of a level sensor to define the azimuth plane offset, a DGPS antenna receiver subsystem, imaging sensors of any kind to provide the distant feature alignment, and a laptop computer to run algorithms of the current invention and to integrate the other hardware inputs. The laptop, DGPS, and imaging system may be generic in nature. The leveling sensor, which may also be generic, simply requires accuracy to serve as an input to the total calibration accuracy.

The system of the present invention employs a geospatial framework for unifying multiple sensors. The system is scalable so that it can incorporate any number of users and sensors. It may support over a thousand video and non-video sensors, and allow many users with customized system privileges. Some of the features that are included in the present invention that are not found in the prior art systems include integrated video analytics for automated verification; integrated analog video capture; and a DTED database. The camera can be operated in an auto tilt mode, and the system has a long range slew to cue. There is an integrated radar computer which may have a radar auto start feature.

The distant feature alignment feature of the invention herein utilizes a precision software calibration algorithm (FIG. 11B) along with the DTED to provide for precision calibration to enhance system accuracy beyond that achieved by leveling the mast and applying the raw DGPS heading to the system. This ensures that when the operator slews to a target that the target lies in the camera field of view (FIG. 11D). The calibration process is divided into tilt and azimuth. The 360 deg tilt calibration provides a software correction ensuring accurate camera tilt. The azimuth calibration uses the DGPS heading as a rough approximation. Visual alignment with a geographic feature, combined with DTED data, allows the residual azimuth error to be eliminated. This software calibration procedure corrects for mechanical inaccuracies.

The system provides Real Time Pan and Tilt Pointing Accuracy, so that when an operator sees a detected item of interest (IOI) on the terrain map, he/she can command the camera to automatically slew to the IOI position on the ground. The target will be seen within the camera's field-of-view without manual intervention. The system uses the DTED data to compute the correct elevation angle for Pan/Tilt. This process eliminates the need to use a Laser Range Finder to identify the correct camera elevation angle, simplifying the operator's workload by eliminating any manual camera adjustments of azimuth and elevation.

The system uses 3-D map data to provide accurate target positioning, elevation data and distance measurement between the system and target to accurately calculate the correct pitch required for pointing the camera to the target.

The better enable the Camera Field of View, the system provides the operator an option to show the ellipsoidal camera field-of-view display on the map. This ellipsoid is a function of the pan and tilt values and the camera zoom. This feature will help the operator precisely locate an IOI that is seen on the video. The operator can move the mouse to the ellipsoid on the map and see the GPS coordinates corresponding to the mouse pointer.

The system also automatically optimizes the acceleration and deceleration profile, when the operator utilizes the slew to click feature. The software adjusts the slewing rate based on optimum acceleration and deceleration of the pan tilt unit when approaching to the targets azimuth position. This process eliminates the overshooting of the pan tilt unit.

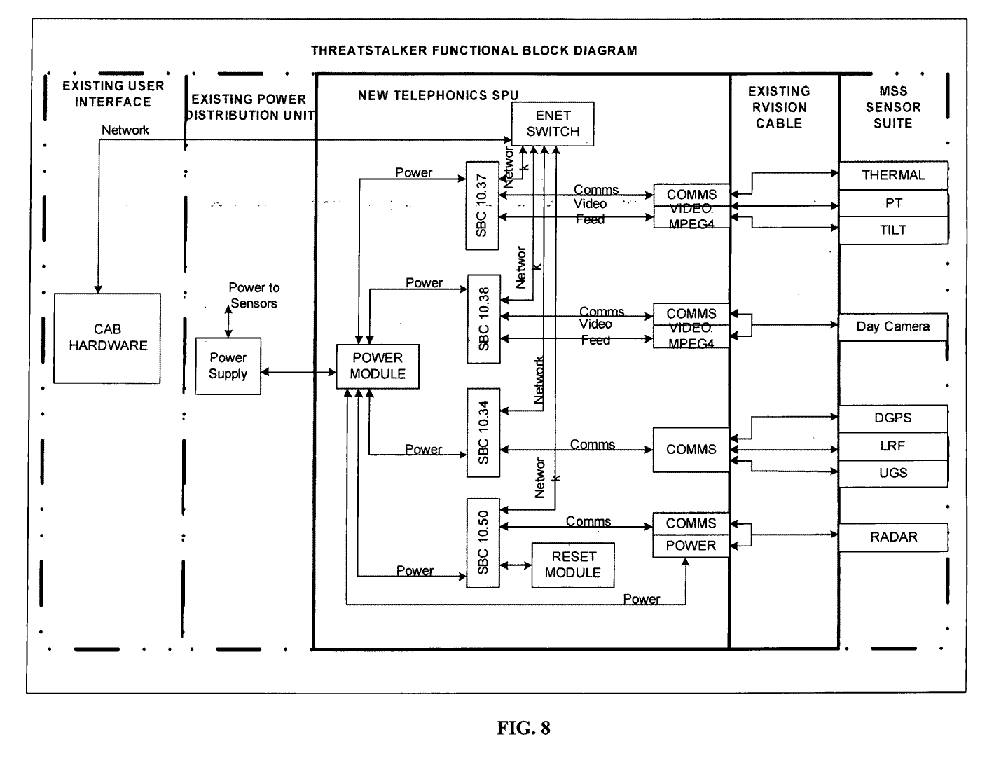

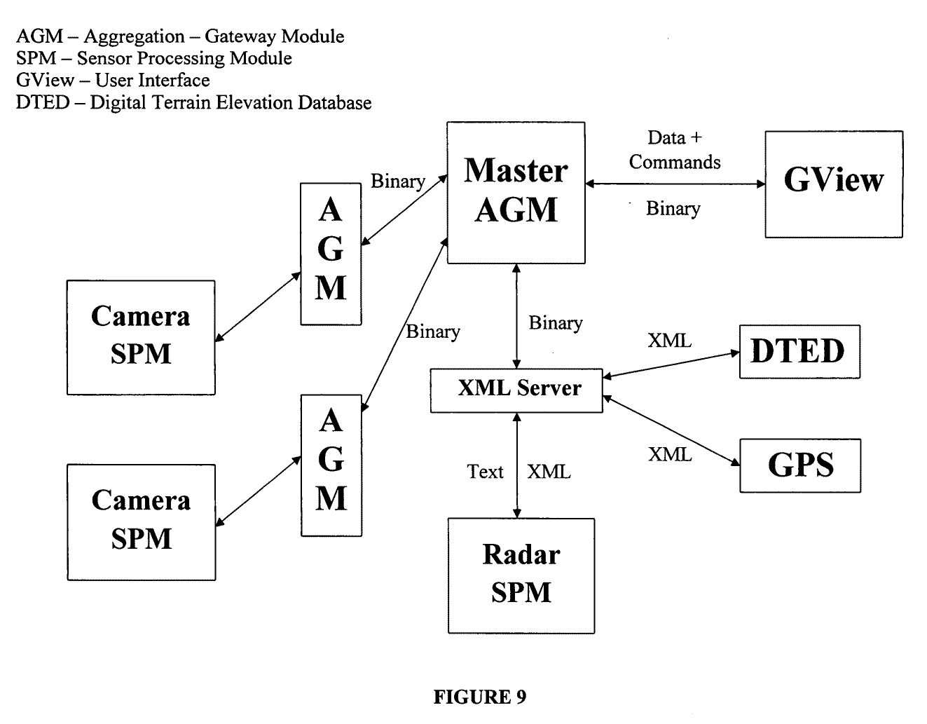

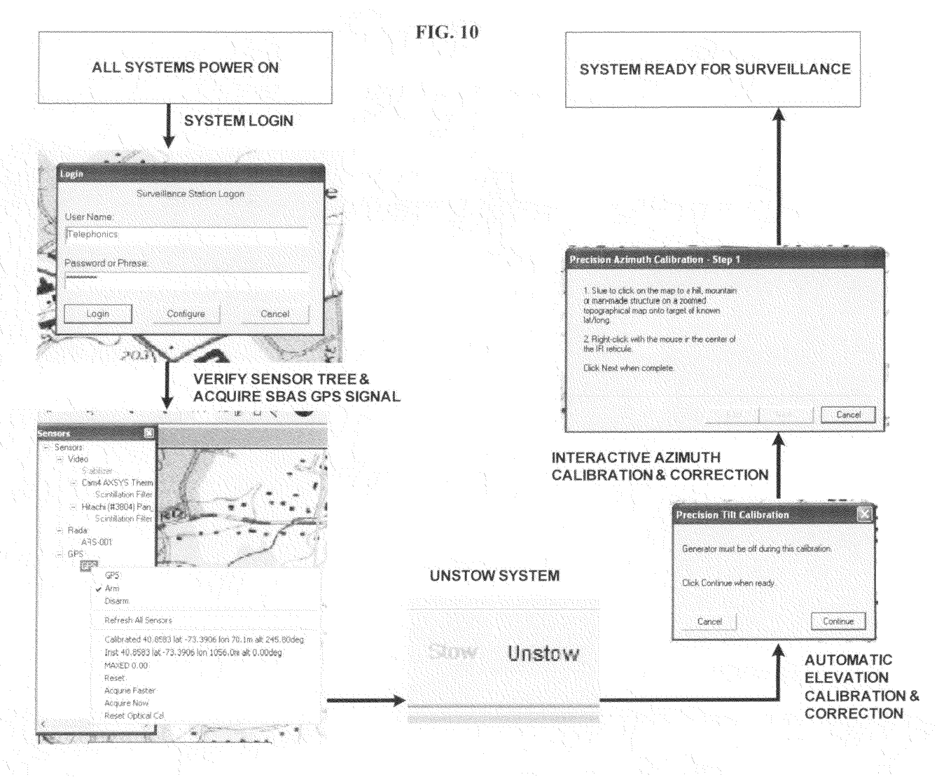

As seen in FIGS. 6 to 9, there may be a signal processing module (SPM). Each sensor used in the system has a dedicated signal processing module. The signal processing module provides an interface between the archive gateway module (AGM) and the device driver. The signal processing module acquires video preferably using IP cameras over TCP/IP. It digitizes analog cameras and decompresses data. The SPM also processes video. It outputs data on the network, utilizes JPEG and MPEG imagery. The SPM also performs camera automations. It controls Pan Tilt Camera Tours, and pans, tilts and zooms the camera based on target behavior. There is also one SPM per video channel.

The AGM is the gateway for inter-module communication. It supports the SPM and other AGMs. The AGM maintains a packet log, if a packet log is required. It also maintains routing tables to locate each module on the network. The AGM performs basic routing of all commands and data as well as maintains bandwidth limits.

The server is preferably an XML server, and it has the function of acting as an intermediary bi-directional translator between XML and VSAM formatted message.

Using the system of the present invention, a user is able to perform automatic mast tilt calibration that dwells at predetermined pan angles and averages measurements to reduce noise. Tilt Data interpolation and curve fitting present in the system eliminates electromagnetic interference from power lines and other noise sources, and eliminates errors due to low frequency platform motion.

The system also performs, by way of an algorithm, mast stability measurements that assess the mechanical stability of mast by comparing the difference between the measured mast tilt vs. pan angle characteristic to the ideal curve for a perfectly stable mast. The system alerts the user when the mast stability falls below a specific tolerance. Any of the algorithms herein may be written in C/C++ for both Linux and Windows, and may also provide support for third-party software packages.

If desired, there may also be a user interface feature that allows the system operator to perform a precise optical alignment procedure. This applies to extendable masts where the system Northing is derived from a Differential GPS attached at the bottom of the mast. The system eliminates calibration errors due to the twist along the mast that occurs when the mast is deployed.

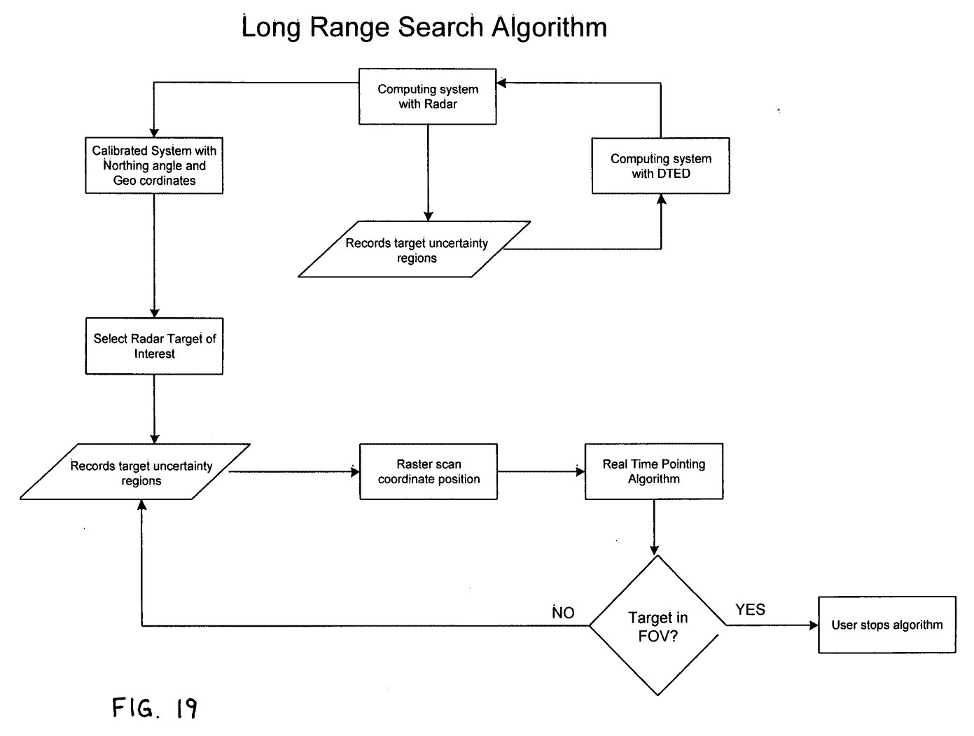

A digital terrain elevation database is present that facilitates automatic sensor tilt commands when a slew command is issued. There is a means for automatically setting camera field-of-view based on radar target distance. The system also estimates the uncertainty region for reported radar targets (see FIG. 19). Another feature is the ability of the pan/tilt unit to follow a search pattern computed from the radar uncertainty region when a slew-to-cue command is issued. A raster scan and spiral scan pattern is used to localize the target in the sensor field of view.

Radars provide robust wide area surveillance and target detection while cameras support precise target identification within a narrow field of view. Together, these sensor types provide a quick and accurate threat detection and identification system whereby the radar directs the camera to a target of interest in a process known as slew-to-cue. The present invention enables the integration of multiple sensors and enhances the complementary target profiling capabilities of radars and cameras, regardless, of the distributed geolocation of the sensors. Slew-to-cue is a key feature and supports timely and accurate target location and identification. Mismatch of the camera and radar fields of view are characteristic issues of long-range range slew-to-cue.

Traditional radar/camera slew-to-cue functionality in integrated security systems relies on using a wide field of view camera to account for: 1) system latencies and target movement, 2) instrument and system calibration errors and 3) uncertainties in the reported target location due to the finite spatial resolution of the radar system and other sensor limitations. FIG. 6 depicts a typical short-range surveillance scenario where the field-of-view (FOV) of the cameras and the effective radar FOV for a particular azimuth are shown as wedges. Because of the wide field of view of the camera, latencies and other inaccuracies do not affect the slew-to-cue process where the radar target data is used to point the camera.

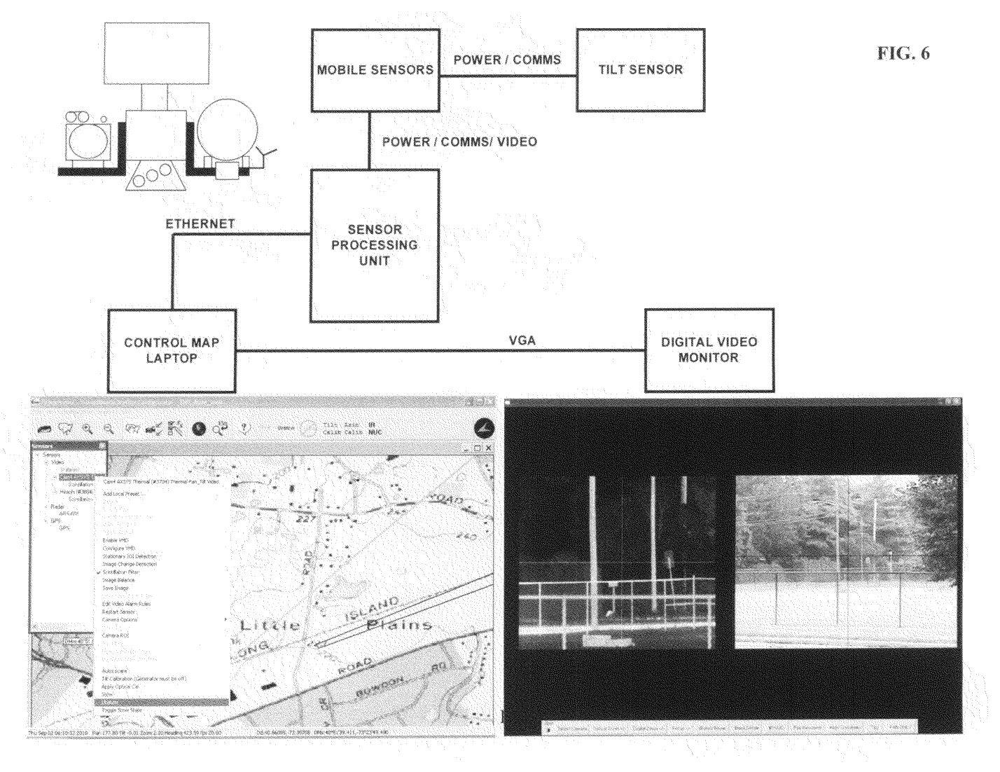

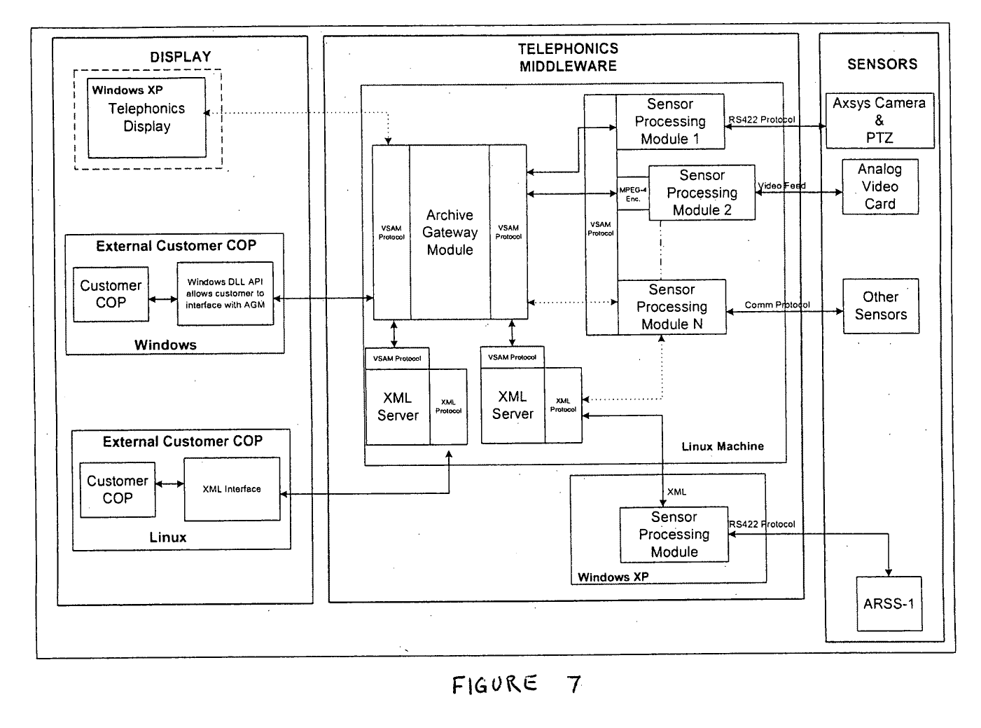

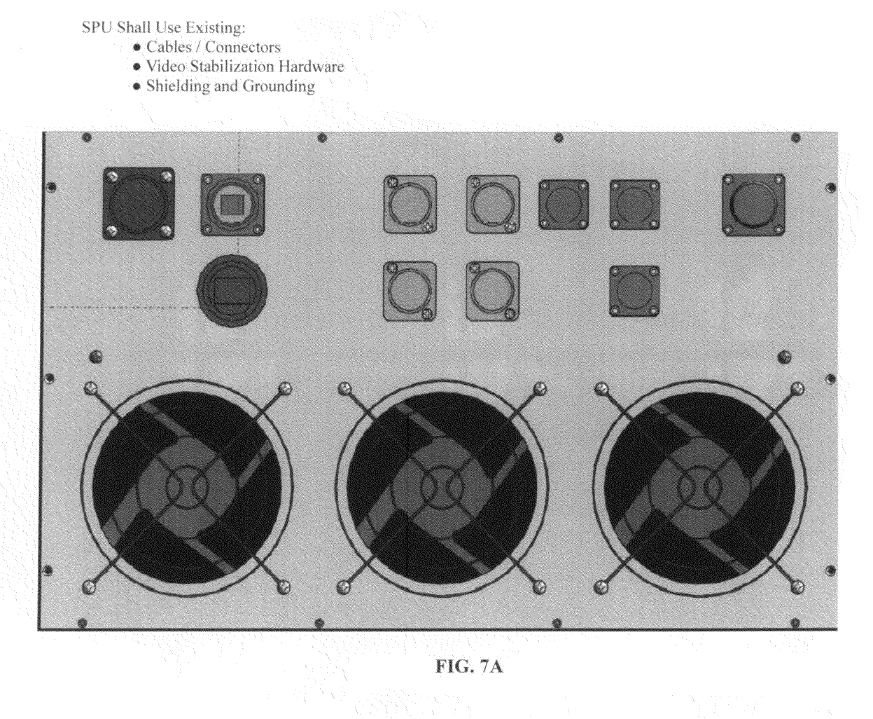

In the long-range detection scenario, the geometry is strikingly different. Here, the ratio of the size of the camera and radar fields of view is inverted. FIG. 7 shows that the radar (light area) FOV is very coarse compared to that for the camera (dark area). Given the uncertainty of the radar-derived target position, the camera may or may not detect the target as it only roughly knows the true target location.

The problem of precisely pointing a camera at a long-range target can be solved in a number of ways. Low-cost radar networks that synthesize finer resolution by combining data from radars with multiple views of the target have been proposed. However, this approach requires additional infrastructure including N-1 additional sensors, N high bandwidth communications channels and a distributed computing architecture for processing multiple radar data feeds. A low cost method using minimal sensor and processing resources, such as that described herein, is preferable. Here, the up-front cost, potential for equipment failure, and maintenance effort are minimized.

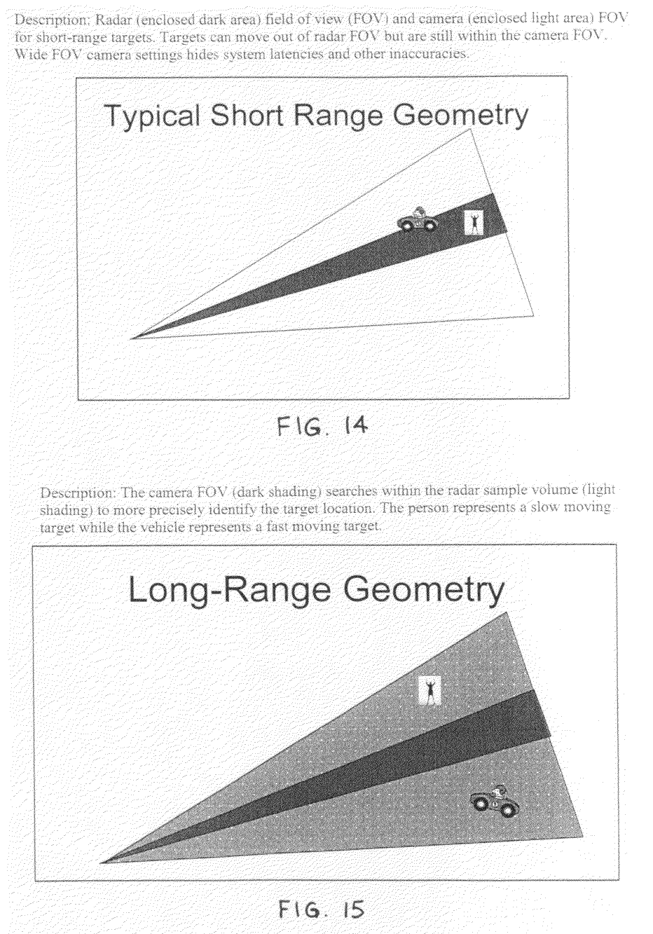

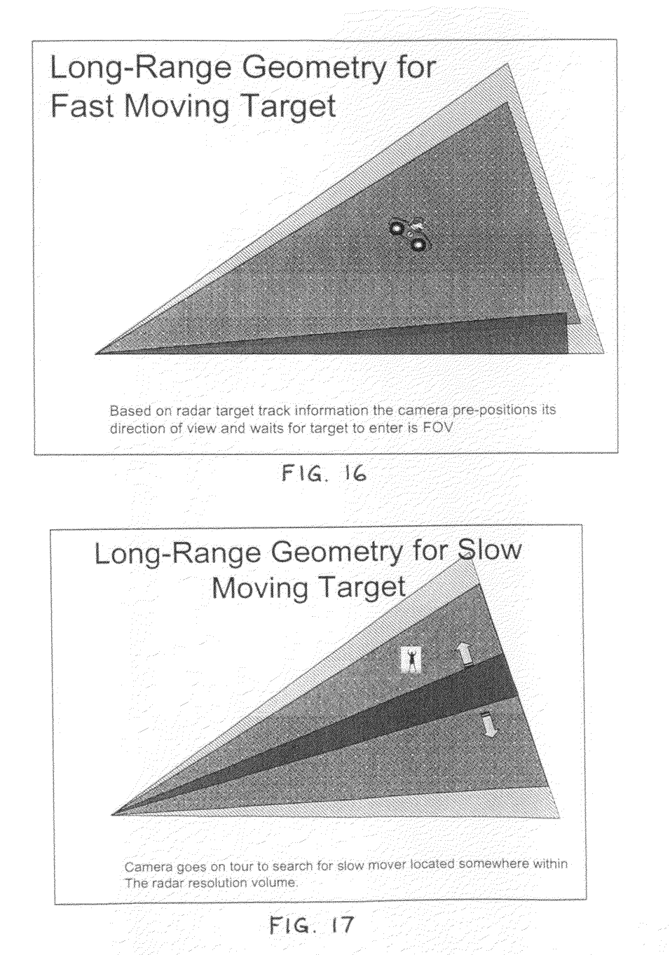

The present invention uses a scheme for long-range detection that considers range, camera and radar FOV, and target motion. It is designed to minimize the latency in the slew-to-cue process and facilitate accurate camera positioning. The problem can be broken down into two classes. The person represents a slow moving target while the vehicle represents a fast moving target. At long range the process results in the situation shown in FIG. 15 where the camera may or may not point at and therefore detect the target reported by the radar.

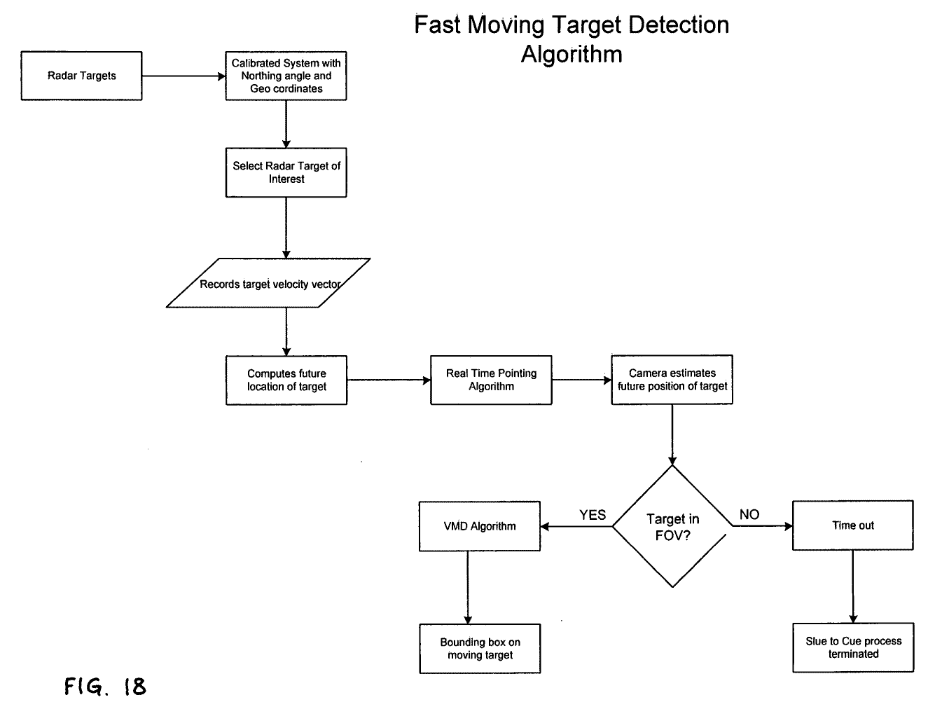

Fast moving targets can quickly translate across the radar field of view. The strategy for capturing these targets with cameras is to utilize the target velocity vector reported by the radar to anticipate the future location of the target. The camera will then point at a fixed angle ahead of the target and wait for the target to arrive in the camera FOV. FIG. 18 shows this scenario. Here, the striped region indicates the region where the target is likely to be located. The radar sample volume is illustrated by the medium-dark textured shading. The camera FOV (darker region) shows the positioning of the camera ahead of the target. Once the target enters the camera FOV the camera can remain in this position and utilize the video that was briefly captured to ID the target or the video motion detection (VMD) capability of the software can be used to track the target with the camera. It is possible that the target reverses course and never enters the camera FOV. In this situation, there is a timeout that corresponds to the target velocity. After this time elapses, the slew-to-cue process is abandoned for the given target and the camera is released to respond to other commands. The process steps of the fast moving target detection algorithm are illustrated in FIG. 18.

It is of course possible, in a situation requiring a series or rapid deployments and surveillance checks in hilly terrain or canyon-like topography, to not have the guy wire supports secured to the mounting surface before the mast is extended and the northing calibration and other adjustments processes are completed. The arrangement, although far less stable for a long period of time, may nonetheless prove accurate targeting using the algorithms of the present invention if there were favorable environmental conditions.

The examples and descriptions provided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

We claim:

1. A system for providing stabilization and tilt corrections for an elevated surveillance platform to achieve highly accurate and rapid slewing of surveillance equipment, said system comprising:
a mast, said mast having a lower end connected to a mounting surface, and an upper end;
a sensor package mounted to said mast upper end, said sensor package comprising one or more pieces of surveillance equipment, and a calibration sensor package, said calibration sensor package comprising measurement hardware;
a pan-tilt unit, said pan-tilt unit orienting said sensor package to a desired azimuth and elevation angle;
a mechanical mast stabilization arrangement comprising a torque arm and guy wires; said torque arm being rigidly mounted to said mast at a location proximate to said mast top end, and being oriented generally transverse to said mast; said guy wires stabilizing said torque arm by tensioning said torque arm relative to said mounting surface, said guy wires being oriented to provide anti-twist and anti-sway support for said mast; and
a computer system coupled to said sensor package; said computer system providing instructions to said pan-tilt unit based upon a measurement of said measurement hardware and corrections from one or more algorithms.

2. The system according to claim 1, wherein said anti-twist and anti-sway guy wire orientation comprises at least two pairs of guy wires mounted in a crisscrossed arrangement.

3. The system according to claim 2, wherein said crisscrossed guy wire arrangement comprises a first pair of guy wires with each being attached at a first end to said torque arm first end, and a second end of said wires being attached to said mounting surface, said guy wires of said first pair passing by opposite sides of said mast to straddle said mast and be attached to said mounting surface on a side of said mast opposite to said torque arm first end; and a second pair of guy wires with each being attached at a first end to said torque arm second end, and a second end of said wires being attached to said mounting surface, said guy wires of said second pair passing by opposite sides of said mast to straddle said mast and be attached to said mounting surface on a side of said mast opposite to said torque arm second end.

4. The system according to claim 3, wherein said calibration sensor package comprises a tilt sensor with a precision compass.

5. The system according to claim 4, wherein said one or more algorithmic solutions comprises a mast tilt algorithm, said mast tilt algorithm utilizing said measurement to achieve automatic electronic leveling of said sensor package to eliminate azimuth and elevation pointing errors.

6. The system according to claim 5, wherein said mast tilt calibration algorithm provides for dwell of said surveillance equipment at predetermined pan angles.

7. The system according to claim 6, wherein said mast tilt calibration algorithm averages measurements to reduce noise.

8. The system according to claim 7, wherein said one or more pieces of surveillance equipment comprises a camera, said camera being coupled to said computer system whereby said camera field of view may be adjusted by said computer system.

9. The system according to claim 8, wherein said one or more pieces of surveillance equipment further comprises surveillance radar, said surveillance radar being coupled to said computer system whereby said surveillance radar sample volume may be adjusted by said computer system.

10. The system according to claim 9 wherein said camera is from the group consisting of: a daylight camera; a night capable camera; a dual capable day/night camera, and a dual capable color/infrared camera.

11. The system according to claim 10, wherein said system accomplishes a northing alignment procedure.

12. The system according to claim 11, wherein said system further comprises a differential GPS antenna receiver, and wherein said an alignment procedure comprises calibration to geographic north using differential GPS data.

13. The system according to claim 12, wherein said system further comprises a digital terrain elevation database, and wherein said alignment procedure further comprises optically targeting a static geographic feature within said database.

14. The system according to claim 13, wherein said system further comprises a field of view algorithm, said field of view algorithm automatically setting said camera field of view based on radar target distance.

15. The system according to claim 14, wherein said system further comprises an estimation algorithm, said estimation algorithm providing estimates of an uncertainty region for reported radar targets.

16. The system according to claim 15, wherein said system further comprises a search pattern algorithm, said search pattern algorithm using raster scan and spiral scan search patterns to localize a target within said camera and said radar field of view.

17. The system according to claim 16, wherein said system further comprises a stability measurement algorithm, said measurement algorithm assessing mast mechanical stability by comparing measured mass tilt versus pan angle characteristics to idealized characteristics of a perfectly stable mast.

18. The system according to claim 17, wherein said stability measurement algorithm initiates an alert when mast stability fails to reach specific tolerances.

19. The system according to claim 18, wherein a tilt data interpolation and curve fitting algorithm eliminates electromagnetic interference and low frequency platform motion errors.

20. A system for providing stabilization with automated corrections for ground surface mounted surveillance platforms to achieve highly accurate and rapid slewing of surveillance equipment, said system comprising:
a mast, said mast having a lower end and an upper end;
a sensor package mounted to said mast upper end;
a pan-tilt unit, said pan-tilt unit orienting said sensor package to a desired azimuth and elevation angle;
a mechanical mast stabilization arrangement comprising a torque aim and one or more guy wires;
a computer system coupled to said sensor package; said computer system providing instructions to said pan-tilt unit; and a
a calibration sensor package.

21. The system according to claim 20, wherein said sensor package comprises one or more articles of surveillance equipment.

22. The system according to claim 21, wherein said surveillance equipment includes a radar system and a camera.

23. The system according to claim 22, wherein said calibration sensor package comprises measurement hardware and a mast tilt calibration algorithm.

24. The system according to claim 23, wherein said measurement hardware comprises a tilt sensor and a compass.

25. The system according to claim 24, wherein said torque arm is rigidly mounted to said mast at a location proximate to said mast upper end.

26. The system according to claim 25, wherein said torque arm is mounted transverse to said mast, and wherein said guy wires stabilize said torque arm by tensioning said torque arm relative to said mounting surface, said guy wires being oriented to provide anti-twist and anti-sway support for said mast.

27. The system according to claim 26, wherein said computer system provides instructions to said pan tilt unit based upon data measurements and an algorithm.

28. The system according to claim 27, wherein said calibration sensor package and said mast tilt calibration algorithm provide for automatic electronic leveling of said camera.

29. The system according to claim 28, wherein said automatic electronic leveling of said camera eliminates azimuth and elevation pointing errors.

30. The system according to claim 29, wherein said mast tilt calibration algorithm provides for dwell of said surveillance equipment at predetermined pan angles.

31. The system according to claim 30, wherein said mast tilt calibration algorithm averages measurements to reduce noise.

32. The system according to claim 31, wherein said camera is coupled to said computer system, and wherein said camera field of view may be adjusted by said computer system.

33. The system according to claim 32, wherein said system further comprises a digital terrain elevation database, said digital terrain elevation database facilitating automatic camera tilt angle positioning.

34. A system for providing mechanical stabilization and tilt corrections for a mast to achieve highly accurate and rapid slewing of surveillance equipment mounted thereon, said system comprising:
a mast, said mast having a lower end and an upper end, said mast lower end being affixed to a mounting surface;
surveillance equipment, said surveillance equipment being adjustably mounted to said mast upper end;
a pan-tilt unit, said pan-tilt unit orienting said surveillance equipment to a desired azimuth and elevation angle;
a mechanical mast stabilization arrangement comprising an anti-torque member and guy wires; said anti-torque member being rigidly mounted to said mast at a location proximate to said mast top end, and being oriented generally transverse to said mast; said guy wires stabilizing said anti-torque member by tensioning said anti-torque member relative to said mounting surface, said guy wires being oriented to provide anti-twist and anti-sway support for said mast;
a computer system coupled to said surveillance equipment; said computer system providing instructions to said pan-tilt unit based upon data measurement and an algorithm; and
a calibration sensor package, said calibration sensor package comprising measurement hardware and a mast tilt calibration algorithm, said calibration sensor package and said mast tilt calibration algorithm providing for electronic leveling of said camera.

35. A system for providing tilt corrections for a mast to achieve highly accurate and rapid slewing of surveillance equipment mounted thereon, said system comprising:
a mast, said mast having a lower end and an upper end, said mast lower end being affixed to a mounting surface;
surveillance equipment, said surveillance equipment being adjustably mounted to said mast upper end;
a pan-tilt unit, said pan-tilt unit orienting said surveillance equipment to a desired azimuth and elevation angle;
a computer system coupled to said surveillance equipment and said pan tilt unit; said computer system providing instructions to said pan-tilt unit based upon data measurements and an algorithm; and
a calibration sensor package; said calibration sensor package comprising measurement hardware and a mast tilt calibration algorithm, said calibration sensor package and said mast tilt calibration algorithm providing for electronic leveling of said camera.
